(19) United States
(12) Patent Application Publication
(10) Pub. No.: US 2025/0190563 A1
(43) Pub. Date: Jun. 12, 2025

(54) RESPONSE FILTERING TO DETECT MALWARE

(71) Applicant: Bank of America Corporation, Charlotte, NC (US)

(72) Inventors: Aaron Buchanan, Mint Hill, NC (US); Jeffrey Felipe, Weddington, NC (US); Robert Timothy Leedy, JR., Belmont, NC (US); Dana Tishgarten Mackay, Charlotte, NC (US); Heidi L. Magura, Charlotte, NC (US); Karen Mcfeeters, York, SC (US); James Siekman, Charlotte, NC (US); Stephen J. Williams, Charlotte, NC (US); Michael Thomas Malarkey, Waxhaw, NC (US)

(73) Assignee: Bank of America Corporation, Charlotte, NC (US)

(21) Appl. No.: 18/531,457

(22) Filed: Dec. 6, 2023

(51) Int. Cl. G06F 21/56; G06F 21/55

(52) U.S. Cl. CPC G06F 21/566; G06F 21/554

(57) ABSTRACT

Enterprise organizations often have thousands or tens of thousands of employees accessing various websites while conducting business. Users may inadvertently reach compromised websites, unsecure websites, and/or websites that include broken links, which may be used by bad actors to redirect users to websites that include malware threats. Accordingly, arrangements described herein provide for real-time detection and notification of non-functioning websites to enable users to avoid potential malicious acts associated with these non-functioning websites.

### BACKGROUND

Aspects of the disclosure relate to electrical computers, systems, and devices for providing response filtering for detection and notification of malware in websites accessed by computing devices or systems.

Enterprise organizations can employ thousands or even tens of thousands of employees who may be using enterprise computing devices to access various websites in the course of business. However, users may inadvertently make attempts to reach websites that are compromised, have broken links, or are not secure. For instance, users may try to reach websites, or pages within websites, that no longer exist or have broken or corrupted links. The website hosting server typically returns the hypertext transfer HTTP 404 standard response error code, “page not found,” to indicate that the server could not find what was requested. These no longer existing websites or webpages increase the risk that bad actors may implant malware within these broken websites or webpages to carry out malicious activity against visitors. These bad actors may attempt to return fake or alternative webpages to capture users' information or ransomware. Accordingly, it is advantageous to provide response filtering so that a user avoids reaching these compromised websites or webpages to avoid any malicious activity.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with detecting malware and efficiently notifying users of potential threats.

As discussed more fully herein, users may input or type a website address into a browser address bar of a web browser application executing on a user computing device. In an aspect of the disclosure, a response filtering, detection, and notification system may determine whether a response to a user's webpage request includes a non-functional website. The response filtering, detection, and notification system may be positioned between users and external servers to detect and intercept receipt of a HTTP 404 response error code or other standard response codes. In response to receiving the HTTP 404 response error code or other standard response codes, the response filtering, detection, and notification system may generate alternative custom web page responses to be received by the requesting user to protect the user from malware or other discussed risks.

In another aspect of the disclosure, a machine learning model may be part of the response filtering, detection, and notification system. The machine learning model may analyze the user input to determine the likelihood that the user input includes a non-functioning or compromised website.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing malware detection and notification functions in accordance with one or more aspects described herein;

FIGS. 2, 3A, and 3B illustrate example user interfaces that may be generated in accordance with one or more aspects described herein;

FIG. 4 illustrates an illustrative method for implementing response filtering, detection, and notification functions according to one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, enterprise organizations often have thousands or tens of thousands of employees accessing various websites while conducting business. Users may reach compromised websites, unsecure websites, and/or websites that include broken links, which may be used by bad actors to redirect users to websites that include malware threats. Accordingly, arrangements described herein provide for real-time detection and notification of non-functioning websites to enable users to avoid malicious acts associated with these non-functioning websites.

Accordingly, as discussed more fully herein, users may input or type a website address into a browser address bar of a web browser application executing on a user computing device. In an aspect of the disclosure, a response filtering, detection, and notification system may determine whether a response to a user's webpage request includes a non-functional website. The response filtering, detection, and notification system may be positioned between users and external servers to detect and intercept receipt of a HTTP 404 response error code or other standard response codes. In response to receiving the HTTP 404 response error code or other standard response codes, the response filtering, detection, and notification system may generate alternative custom web page responses to be received by the requesting user to protect the user from malware or other discussed risks.

In another aspect of the disclosure, a machine learning model may be part of the response filtering, detection, and notification system. The machine learning model may analyze the user input to determine the likelihood that the user input includes a non-functioning website. In an embodiment, the machine learning model may identify broken websites in a safe isolated internal system and keep track on these broken websites to prevent internal users from receiving data from these websites. For instance, if the website address matches functioning, safe website addresses the model may output a low likelihood of malware detection. However, if the user inputs data that does not match a safe, functioning website, the model may identify a greater likelihood of malware detection. Accordingly, if the identified likelihood is sufficiently high, the system may generate and transmit to the user an alternative custom webpage in response to the user's webpage request. The system based on the identified likelihood may update or validate the machine learning model and transmit a notification and/or user interface to an administrative system.

These and various other arrangements will be discussed more fully below.

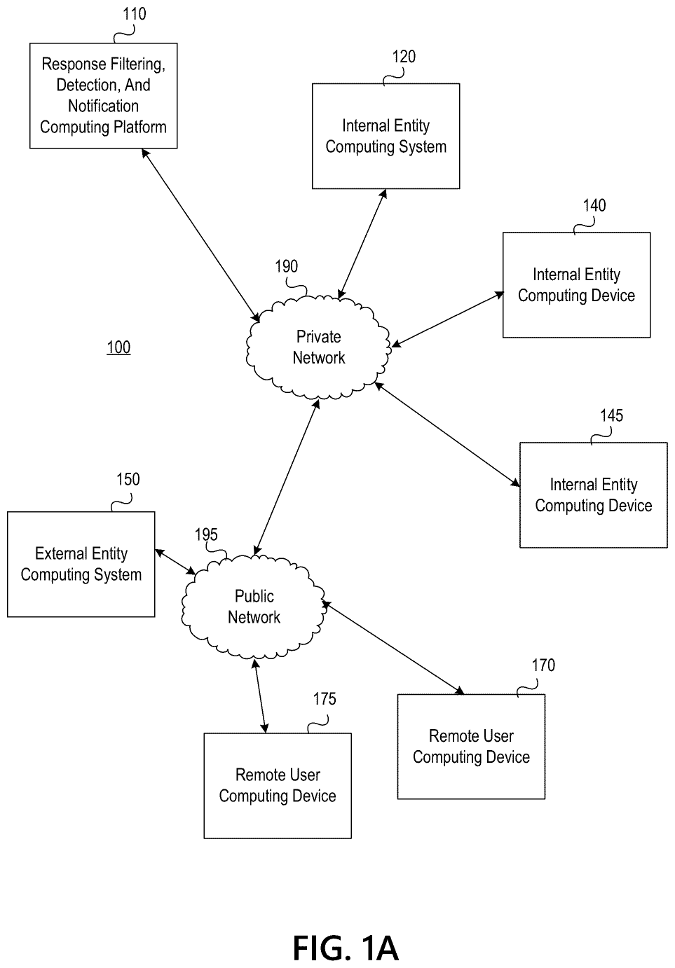

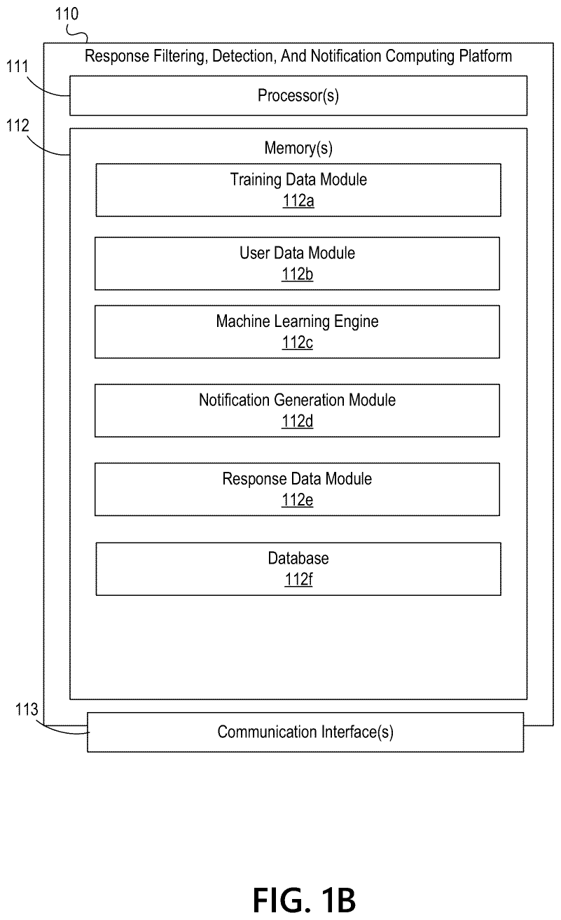

Aspects described herein may be implemented using one or more computing devices operating in a computing environment. For instance, FIGS. 1A-1B depict an illustrative computing environment for implementing response filtering, detection, and notification functions in accordance with one or more aspects described herein. Referring to FIG. 1A, computing environment 100 may include one or more computing devices and/or other computing systems. For example, computing environment 100 may include response filtering, detection, and notification computing platform 110, internal entity computing system 120, internal entity computing device 140, internal entity computing device 145, external entity computing system 150, remote user computing device 170 and/or remote user computing device 175. Although one internal entity computing systems 120, two internal entity computing devices 140, 145, one external entity computing system 150 and two remote user computing devices 170, 175 are shown, any number of systems or devices may be used without departing from the invention.

Response filtering, detection, and notification computing platform 110 may be configured to perform intelligent, dynamic, and efficient response filtering, detection, and notification. Response filtering, detection, and notification computing platform 110 may detect compromised websites that include websites that are unsecure and/or websites that include broken links, which may be used by bad actors to redirect users to websites that include malware threats.

For instance, response filtering, detection, and notification computing platform 110 may receive user input requesting access to a website. In some examples, the user input may be received in a web browser address bar. In some examples, the user input received in the address bar may be analyzed or evaluated in real-time or near real-time (e.g., as the user is typing in the address bar). Upon receiving a response from the destination web server, response filtering, detection, and notification computing platform 110 may analyze the websites response to determine if the response code is appropriate before allowing the response to be forwarded to the requesting user. If the response code returned is a HTTP 404 response error code, page not found or file not found, response filtering, detection, and notification computing platform 110 may generate a custom web page and forward the generated custom web page to the user. Response filtering, detection, and notification computing platform 110 may forward the received HTTP 404 response error code to an isolated internal entity computer system for examination and determination of whether the website includes malware or other potential threats.

In an embodiment, a consortium could be established to share information regarding compromised websites so that users belonging to the consortium may be protected from reaching compromised websites. Shared knowledge amount the consortium may assist in preventing additional users from reaching compromised websites.

An analysis by internal entity computing system 120 may be made at the enterprise level to determine the number of attempts to websites returning an HTTP 404 response error code to assist in determining why users are attempting to reach these websites. The analysis may determine if additional corrective action needs to be implemented to reduce malware threats. For instance, if internal entity computing system 120 determines that numerous attempts to the same compromised website are occurring, response filtering, detection, and notification computing platform 110 may upon analysis and determination of what website a user in real-time or near real-time is attempting to reach, (e.g., as the user is typing in the address bar), generate a custom web page and forward the generated custom web page to the user. In an embodiment, response filtering, detection, and notification computing platform 110 may prevent users from reaching determined compromised websites. This real-time or near real-time determination and generation of custom web pages may reduce malware threats for an enterprise and/or individual computer device user.

Response filtering, detection, and notification computing platform 110 may further evaluate user input as it is being input into an address bar. Accordingly, if user input matches a website or website address identified as safe, a first visual indicator may appear (e.g., a first color may be used to highlight the user input, a first hashing or pattern may be used to highlight the font, or the like). Additionally or alternatively, as the user input diverges from a known or safe website or website address, a second visual indicator may be used to identify a portion of the user input that is not associated with the safe or known website or website address (e.g., a second color or hashing pattern may be used to highlight the user input or the portion of the user input that is divergent from the safe website, or the like).

In another aspect of the disclosure, upon receiving the user input (e.g., website address, portion of a website address, or the like), response filtering, detection, and notification computing platform 110 may analyze the input using, for instance, a machine learning model. In some examples, the machine learning model may be trained using external data to identify safe websites or website addresses, unsafe or potentially malicious websites or website addresses, and the like. In some examples, historical user data may also be used to train the machine learning model. For instance, if a vast majority of users input a website address and a few users input a website address that is similar but not identical to the website address input by most users, the machine learning model may detect a potential issue. In other examples, response filtering, detection, and notification computing platform 110 may test and monitor external website responses, via an isolated system, to determine if users previously used or most often used websites are currently operational and returning appropriate response codes. This monitoring may be occurring in the background and used as input to machine learning model.

In some examples, the machine learning model may generate an output. For instance, the machine learning model may generate an output indicating a likelihood that the user input is associated with a compromised website. If the likelihood meets or exceeds a threshold, a user interface may be generated and automatically displayed on a user computing device from which the user input was received. In some examples, the user interface may cover a large portion of a user display (e.g., greater than 50%, greater than 75%, greater than 90% or the like).

Internal entity computing system 120 may be or include one or more computing systems, devices, or the like, (e.g., servers, server blade, or the like) that may include one or more computing components (e.g., processor, memory, or the like) that may host or execute one or more applications of an enterprise organization. For instance, internal entity computing system 120 may host or execute one or more applications in use by an enterprise organization (e.g., internally during the course of business, externally to provide services to one or more users, and the like), may include one or more proxy servers, may include historical web browsing data, may store one or more enterprise organization data security rules or policies, and the like. Accordingly, internal entity computing system 120 may capture browser data of a user that may be used to train the machine learning model, may capture proxy telemetry data that may be used to train the machine learning model, and the like. Internal entity computing system 120 may further store or execute one or more enterprise organization security policies (e.g., malware scanning policies or software, data associated with blocked websites, and the like). In some examples, internal entity computing system may store data associated with previously evaluated websites.

Internal entity computing device 140 and/or internal entity computing device 145 may be or include one or more computing devices (e.g., laptops, mobile devices, desktops, tablets, and the like) associated with one or more users internal to the enterprise organization (e.g., employees of the enterprise organization). Internal entity computing device 140 and/or internal entity computing device 145 may be used by the users in the course or business (e.g., to access applications and/or data, and the like). In some examples, users may input requests to access one or more websites via a web browser executing on internal entity computing device 140 and/or internal entity computing device 145.

External entity computing system 150 may be or include one or more computing devices or systems (e.g., servers, server blades, and the like) having one or more computer components (e.g., processor, memory, and the like) and may be associated with an entity external to or out outside of the enterprise organization. For instance, external entity computing system 150 may be associated with a vendor or service provider and, in some examples, may provide intelligence data or feeds to the enterprise organization. For instance, data related to safe and/or unsafe or potentially malicious websites or web addresses, known phishing scams, known malware attacks, and the like, may be provided to the enterprise organization from the vendor associated with external entity computing system 150.

Remote user computing device 170 and/or remote user computing device 175 may be or include one or more user computing devices (e.g., smart phones, wearable devices, laptops, desktops, tablets, or the like) that may be used (e.g., by an employee of the enterprise organization, or the like) to request access to one or more websites. For instance, a user associated with the enterprise organization may use their personal device to access one or more websites or web addresses (e.g., via enterprise organization systems) and may input user input requesting access in a web browser address bar via a display of the remote user computing device 170, 175. Remote user computing device 170, 175 may also receive user interfaces generated by response filtering, detection, and notification computing platform 110.

As mentioned above, computing environment 100 also may include one or more networks, which may interconnect one or more of response filtering, detection, and notification computing platform 110, internal entity computing system 120, internal entity computing device 140, internal entity computing device 145, external entity computing system 150, remote user computing device 170, and/or remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, response filtering, detection and notification computing platform 110, internal entity computing system 120, internal entity computing device 140, and/or internal entity computing device 145, may be associated with an enterprise organization (e.g., a financial institution), and private network 190 may be associated with and/or operated by the organization, and may include one or more networks (e.g., LANs, WANs, virtual private networks (VPNs), or the like) that interconnect response filtering, detection, and notification computing platform 110, internal entity computing system 120, internal entity computing device 140, and/or internal entity computing device 145 and one or more other computing devices and/or computer systems that are used by, operated by, and/or otherwise associated with the organization. Public network 195 may connect private network 190 and/or one or more computing devices connected thereto (e.g., response filtering, detection, and notification computing platform 110, internal entity computing system 120, internal entity computing device 140, and/or internal entity computing device 145) with one or more networks and/or computing devices that are not associated with the organization. For example, external entity computing system 150, remote user computing device 170 and/or remote user computing device 175, might not be associated with an organization that operates private network 190 (e.g., because external entity computing system 150, remote user computing device 170 and/or remote user computing device 175 may be owned, operated, and/or serviced by one or more entities different from the organization that operates private network 190, one or more users of the organization, one or more employees of the organization, public or government entities, and/or vendors of the organization, rather than being owned and/or operated by the organization itself), and public network 195 may include one or more networks (e.g., the internet) that external entity computing system 150, remote user computing device 170 and/or remote user computing device 175 to private network 190 and/or one or more computing devices connected thereto (e.g., response filtering, detection, and notification computing platform 110, internal entity computing system 120, internal entity computing device 140, and/or internal entity computing device 145).

Referring to FIG. 1B, response filtering, detection, and notification computing platform 110 may include one or more processors 111, memory 112, and communication interface 113. A data bus may interconnect processor(s) 111, memory 112, and communication interface 113. Communication interface 113 may be a network interface configured to support communication between response filtering, detection, and notification computing platform 110 and one or more networks (e.g., private network 190, public network 195, or the like). Memory 112 may include one or more program modules having instructions that when executed by processor(s) 111 cause response filtering, detection, and notification computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of response filtering, detection, and notification computing platform 110 and/or by different computing devices that may form and/or otherwise make up response filtering, detection, and notification computing platform 110.

For example, memory 112 may have, store and/or include training data module 112a. Training data module 112a may store instructions and/or data that may cause or enable response filtering, detection, and notification computing platform 110 to receive training data from one or more systems or devices (e.g., external entity computing system 150, internal entity computing system 120) and use the training data to train one or more machine learning models hosted or executed by machine learning engine 112c.

Response filtering, detection, and notification computing platform 110 may further have, store and/or include user data module 112b. User data module 112b may store instructions and/or data that may cause or enable the response filtering, detection, and notification computing platform 110 to receive user input data (e.g., user requests to access one or more websites or website addresses) from one or more user computing devices (e.g., internal entity computing device 140, internal entity computing device 145, remote user computing device 170, remote user computing device 175, or the like). The user input data may then be analyzed using, for instance, a machine learning model hosted or executed by machine learning engine 112c.

Response filtering, detection, and notification computing platform 110 may further have, store and/or include machine learning engine 112c. Machine learning engine 112c may store instructions and/or data that may train, execute, update and/or validate one or more machine learning models which may, e.g., be used to identify or determine a likelihood of compromised or unsecure websites. For instance, the machine learning model may be trained to identify patterns or sequences of data that may indicate a likelihood of compromised or unsecure websites. The machine learning model may be able to determine other related links associated with a compromised or unsecure website that should not be requested or visited. In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models.

In an embodiment, machine learning engine 112c may examine logs and other data to determine the top websites that are returning HTTP 404 error codes to internal users across the enterprise. Machine learning engine 112c may be used to determine why internal users are attempting to access those websites. Machine learning engine 112c may determine that for certain websites an autocorrect spelling feature may be added to the system to assist in certain website spellings to reduce the number of received HTTP 404 error response codes. In other embodiments, machine learning engine 112c may determine that at certain times of day a frequently requested website returns HTTP 404 error response codes. Analysis by machine learning engine 112c may assist in reducing received error codes which reduces threat exposure.

Response filtering, detection, and notification computing platform 110 may further have, store and/or include notification generation module 112d. Notification generation module 112d may store instructions and/or data that may cause or enable the response filtering, detection, and notification computing platform 110 to generate, in response to an output, one or more user interfaces that may be transmitted and displayed by a user computing device (e.g., internal entity computing device 140, 145, remote user computing device 170, 175, or the like). For instance, notification generation module 112d may generate a user interface denying access to the requested website due to a security concern. In an embodiment, a custom generated user interface may be displayed to the user in place of the requested website. The custom generated website may include information from internal servers that may assist the user in finding similar information requested based on analysis of original destination address analyzed by machine learning engine 112c. Various other notifications may be generated without departing from the invention.

Response filtering, detection, and notification computing platform 110 may further have, store and/or include response data module 112e. Response data module 112e may update or validate the one or more machine learning models based on feedback or additional received information, may identify one or more enterprise organization entities that should be informed of the compromised website, may generate one or more reports and the like.

Response filtering, detection, and notification computing platform 110 may further include database 112f. Database 112f may store user input data such as websites requested and notification generation data and the like.

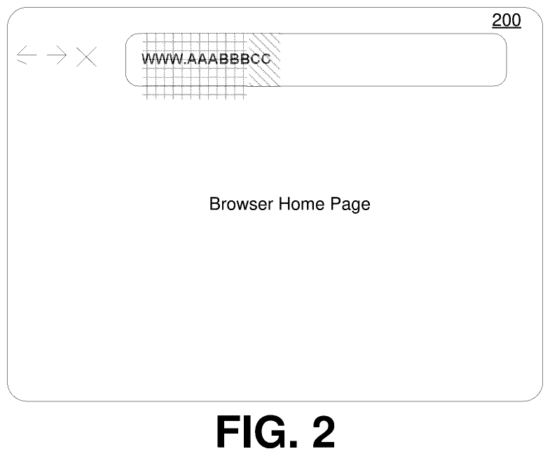

FIG. 2 illustrates one example portion of a web browser 200 including an address bar. The user input or content provided in the address bar includes a website address associated with a website to which a user is requesting access. As shown in FIG. 2, a first visual indicator (e.g., a first type or pattern of hashing, a first color, or the like) may overlay the portion of the user input deemed safe or corresponding to a safe or expected website. However, as the user continues to type in the address bar, a second visual indicator (e.g., different type or pattern of hashing, a second color, or the like) may overlap the portion of the user input that may correspond to potential typosquatting. Accordingly, the user may be alerted to a potential issue based on the visual indicator. In an embodiment, response filtering, detection, and notification computing platform 110 may analyze key stroke inputs to compared against a database or local cache containing a list of previously determined compromised websites. Response filtering, detection, and notification computing platform 110 may display to user while inputting key strokes potential problem websites the user may be intending to submit requests to for information so as to provide real-time security monitoring. If a match occurs, the website may be blocked before a request for information is even transmitted. In an embodiment, the list of potential problem websites may be shared with members of a consortium.

In another embodiment, a user exception list be maintained so that cyber security users or other high security access users may access all restricted websites to analyze and prevent any future threats. For example, most users may be given a Tier 1 clearance, whereas, cyber security users or other high security access users may be given Tier 2 access.

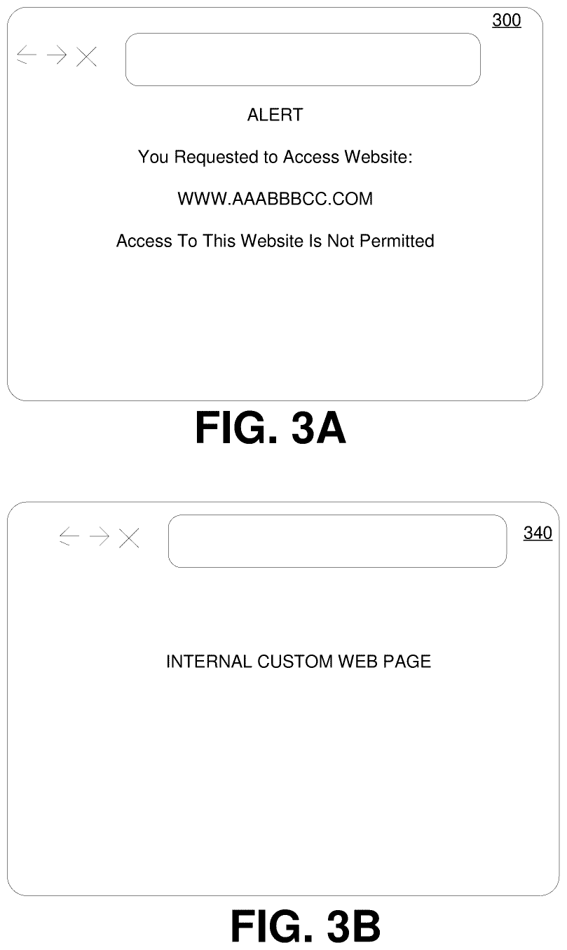

FIG. 3A illustrates another example notification or user interface 300 that may be generated. In FIG. 3A, an alert may be displayed that indicates to a user that the requested webpage is not available or access to the webpage is not permitted. This may be generated based on the machine learning model determining that a webpage on a website may be compromised or include broken links. In an embodiment, machine learning model may determine that a hypertext transfer HTTP 404 response error code, “page not found,” was received as a response to a webpage retrieval request. A custom web page user interface 340, internal to the enterprise, may be generated and displayed to the user such as shown in FIG. 3B in response to the received HTTP 404 response error code.

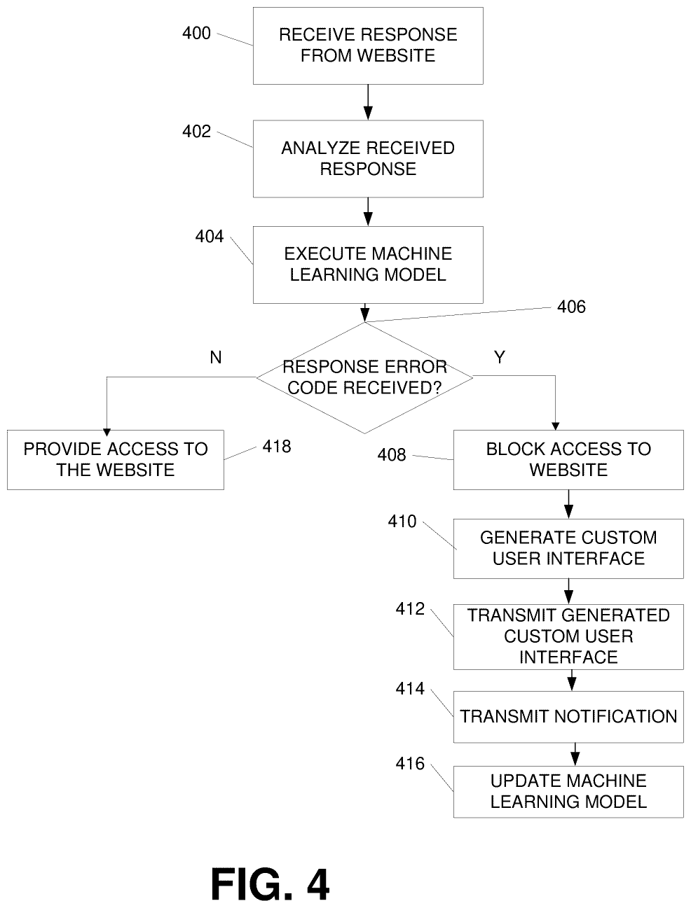

FIG. 4 is a flow chart illustrating one example method of implementing response filtering, detection, and notification functions in accordance with one or more aspects described herein. The processes illustrated in FIG. 4 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 4 may be performed in real-time or near real-time.

At step 400, a response from an external server may be received based on a transmitted request for a webpage of a website from an internal user of a computing device, such as internal entity computing device 140, internal entity computing device 145, remote user computing device 170, remote user computing device 175, or the like. In step 402, the received response from the external server may be analyzed.

In an aspect of the disclosure, the analysis may include executing a machine learning model as shown in step 404. The machine learning model may determine in step 406 if a client side HTTP 404 response error code was returned as a response to the requested website. If a client side HTTP 404 response error code was received, then in step 408 access to the requested website may be blocked. In step 410 a custom user interface may be generated that indicates in-part that requested website is unavailable for access. In step 412, response filtering, detection, and notification computing platform 110 may transmit the generated custom user interface to the user computing device, wherein transmitting the generated custom user interface to the computing device causes the custom user interface to display on a display of the computing device. In step 414, response filtering, detection, and notification computing platform 110 may transmit a notification of the generated custom interface and received client side HTTP 404response error code to an administrative internal server. In step 46, response filtering, detection, and notification computing platform 110 may update the machine learning model based on the determined client side HTTP 404 response error code was returned as part of the response to the requested website.

If in step 406, a client side HTTP 404 response error code was not received, then in step 418, response filtering, detection, and notification computing platform 110 provides the response from the requested website to the web browser of the computing device.

Accordingly, arrangements provided herein enable real-time or near real-time evaluation of requests to access websites based on analysis of received HTTP 404 response error codes. By using a machine learning model that is continuously updated or validated based on user activity data, external data, and the like, the system may learn to improve the accuracy of detecting compromised websites, website that have broken links, and/or websites that are not secure.

In another aspect of the disclosure, determined compromised or broken URLs may be stored in a database and checked to see if the URLs have been fixed using a sandbox server to ensure isolation during testing. For example, a broken link on a web page may be repaired by the website owner. If fixed the URL may be removed from the list and proxy setting altered to allow access to the repaired webpage.

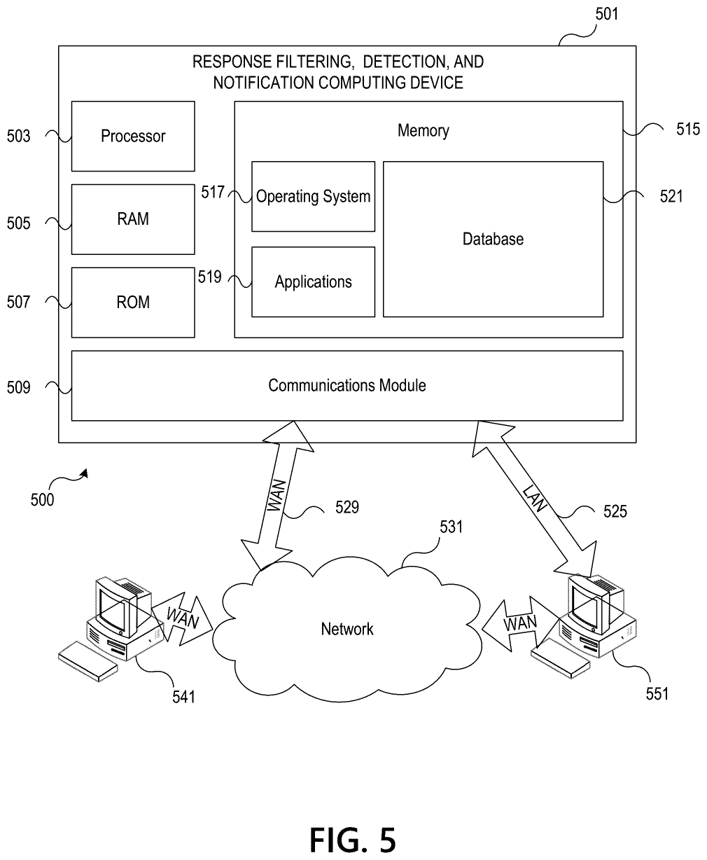

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include response filtering, detection, and notification computing device 501 having processor 503 for controlling overall operation of response filtering, detection and notification computing device 501 and its associated components, including Random Access Memory (RAM) 505, Read-Only Memory (ROM) 507, communications module 509, and memory 515. Response filtering, detection, and notification computing device 501 may include a variety of computer readable media. Computer readable media may be any available media that may be accessed by typosquatting detection and notification computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by response filtering, detection, and notification computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on response filtering, detection, and notification computing device 501. Such a processor may execute computer-executable instructions stored on a computer-readable medium.

Software may be stored within memory 515 and/or storage to provide instructions to processor 503 for enabling response filtering, detection, and notification computing device 501 to perform various functions as discussed herein. For example, memory 515 may store software used by response filtering, detection, and notification computing device 501, such as operating system 517, application programs 519, and associated database 521. Also, some or all of the computer executable instructions for response filtering, detection, and notification computing device 501 may be embodied in hardware or firmware. Although not shown, RAM 505 may include one or more applications representing the application data stored in RAM 505 while response filtering, detection, and notification computing device 501 is on and corresponding software applications (e.g., software tasks) are running on response filtering, detection, and notification computing device 501.

Communications module 509 may include a microphone, keypad, touch screen, and/or stylus through which a user of response filtering, detection, and notification computing device 501 may provide input, and may also include one or more of a speaker for providing audio output and a video display device for providing textual, audiovisual and/or graphical output. Computing system environment 500 may also include optical scanners (not shown).

Response filtering, detection, and notification computing device 501 may operate in a networked environment supporting connections to one or more remote computing devices, such as computing devices 541 and 551. Computing devices 541 and 551 may be personal computing devices or servers that include any or all of the elements described above relative to response filtering, detection, and notification computing device 501.

The network connections depicted in FIG. 5 may include Local Area Network (LAN) 525 and Wide Area Network (WAN) 529, as well as other networks. When used in a LAN networking environment, response filtering, detection, and notification computing device 501 may be connected to LAN 525 through a network interface or adapter in communications module 509. When used in a WAN networking environment, response filtering, detection, and notification computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive, from an external server, a response to a requested website based on user input, the user input including a website address of the requested website inputted via a web browser of a computing device;
analyze the received response from the external server, analyzing the received response including:
executing a machine learning model, executing the machine learning model including determining if a client side HTTP response error code was returned as a response to the requested website;
responsive to determining that the client side HTTP response error code was returned as part of the response to the requested website:
block access to the requested website;
generate a custom user interface that indicates in-part that requested website is unavailable for access;
transmit the generated custom user interface to the user computing device, wherein transmitting the generated custom user interface to the computing device causes the custom user interface to display on a display of the computing device;
transmit a notification of the generated custom interface and received client side HTTP response error code to an administrative internal server;
update, based on the determined client side HTTP response error code was returned as part of the response to the requested website, the machine learning model; and
responsive to determining that the client side HTTP response error code was not returned as part of the response to the requested website, provide the response from the requested website to the web browser of the computing device.

2. The computing platform of claim 1, wherein the client side HTTP response error code comprises a client side HTTP 404 response error code.

3. The computing platform of claim 1, wherein the machine learning model is trained using historical web browser data.

4. The computing platform of claim 1, wherein the machine learning model is trained using external data including identified safe websites and identified potentially malicious websites.

5. The computing platform of claim 1, wherein analyzing the received response from the external server is performed in real-time.

6. The computing platform of claim 1, further including instructions that, when executed, cause the computing platform to block future access to the requested website by additional computing devices associated with an enterprise.

7. The computing platform of claim 1, further including instructions that when executed, cause the computing platform to display a visual indicator in the address bar of the web browser indicating that the requested website is unavailable for access, as part of the generated custom user interface.

8. A method, comprising:
receiving, from an external server, a response to a requested website based on user input, the user input including a website address of the requested website inputted via a web browser of a computing device;
analyzing the received response from the external server, analyzing the received response including:
executing a machine learning model, executing the machine learning model including determining if a client side HTTP response error code was returned as a response to the requested website;
responsive to determining that the client side HTTP response error code was returned as part of the response to the requested website:
blocking access to the requested website;
generating a custom user interface that indicates in-part that requested website is unavailable for access;
transmitting the generated custom user interface to the user computing device, wherein transmitting the generated custom user interface to the computing device causes the custom user interface to display on a display of the computing device;
transmitting a notification of the generated custom interface and received client side HTTP response error code to an administrative internal server;
updating, based on the determined client side HTTP response error code was returned as part of the response to the requested website, the machine learning model; and
responsive to determining that the client side HTTP response error code was not returned as part of the response to the requested website, providing the response from the requested website to the web browser of the computing device.

9. The method of claim 8, wherein the client side HTTP response error code comprises a client side HTTP 404 response error code.

10. The method of claim 8, wherein the machine learning model is trained using historical web browser data.

11. The method of claim 8, wherein the machine learning model is trained using external data including identified safe websites and identified potentially malicious websites.

12. The method of claim 8, wherein analyzing the received response from the external server is performed in real-time.

13. The method of claim 8, further including blocking future access to the requested website by additional computing devices associated with an enterprise.

14. The method of claim 8, further displaying a visual indicator in the address bar of the web browser indicating that the requested website is unavailable for access, as part of the generated custom user interface.

15. One or more non-transitory computer-readable media storing instructions that, when executed by a computing platform comprising at least one processor, memory, and a communication interface, cause the computing platform to:
receive, from an external server, a response to a requested website based on user input, the user input including a website address of the requested website inputted via a web browser of a computing device;
analyze the received response from the external server, analyzing the received response including:
executing a machine learning model, executing the machine learning model including determining if a client side HTTP response error code was returned as a response to the requested website;
responsive to determining that the client side HTTP response error code was returned as part of the response to the requested website:
block access to the requested website;
generate a custom user interface that indicates in-part that requested website is unavailable for access;
transmit the generated custom user interface to the user computing device, wherein transmitting the generated custom user interface to the computing device causes the custom user interface to display on a display of the computing device;
transmit a notification of the generated custom interface and received client side HTTP response error code to an administrative internal server;
update, based on the determined client side HTTP response error code was returned as part of the response to the requested website, the machine learning model; and
responsive to determining that the client side HTTP response error code was not returned as part of the response to the requested website, provide the response from the requested website to the web browser of the computing device.

16. The one or more non-transitory computer-readable media of claim 15, wherein the client side HTTP response error code comprises a client side HTTP 404 response error code.

17. The one or more non-transitory computer-readable media of claim 15, wherein the machine learning model is trained using historical web browser data.

18. The one or more non-transitory computer-readable media of claim 15, wherein the machine learning model is trained using external data including identified safe websites and identified potentially malicious websites.

19. The one or more non-transitory computer-readable media of claim 15, wherein analyzing the received response from the external server is performed in real-time.

20. The one or more non-transitory computer-readable media of claim 15, further including instructions that, when executed, cause the computing platform to block future access to the requested website by additional computing devices associated with an enterprise.
